(19) United States
(12) Patent Application Publication
(10) Pub. No.: US 2022/0305983 A1
(43) Pub. Date: Sep. 29, 2022

(54) WIRELESS VEHICLE U-TURN INDICATOR LIGHT

(71) Applicant: USAFE, LLC, Hollywood, FL (US)

(72) Inventors: Brynn A. Cohen, Hollywood, FL (US); Robert L. Tammara, Miramar, FL (US)

(73) Assignee: USAFE, LLC, Hollywood, FL (US)

(21) Appl. No.: 17/656,025

(22) Filed: Mar. 23, 2022

Related U.S. Application Data
(60) Provisional application No. 63/164,668, filed on Mar. 23, 2021.
(60) Provisional application No. 63/164,745, filed on Mar. 23, 2021.

(51) Int. Cl. B60Q 1/34; B60Q 1/26; B60Q 1/00; F21S 43/19

(52) U.S. Cl. CPC B60Q 1/343; B60Q 1/2615; B60Q 1/0076; F21S 43/19

(57) ABSTRACT

A wireless U-turn indicator lamp includes a switch, a wireless transmitter, a wireless receiver, a receiver switch, an indicator lamp. The switch is activated before making a U-turn to illuminate the indicator lamp. The wireless transmitter is connected to the switch. The wireless transmitter transmits a signal when the switch is activated. The wireless receiver receives the signal from the wireless transmitter. The receiver switch is connected to the wireless receiver. The receiver switch is activated when the wireless receiver receives the signal. The indicator lamp is connected to the receiver switch. The indicator lamp illuminates when the receiver switch is activated.

### CROSS-REFERENCE TO RELATED APPLICATIONS

This application claims the benefit of U.S. Provisional Application No. 63/164,668, filed Mar. 23, 2021, and U.S. Provisional Application No. 63/164,745, filed Mach 23, 2021, both of which are hereby incorporated by reference.

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

The invention relates to vehicle turn indicators.

### Description of the Related Art

A U-turn in driving refers to performing a one-hundred-eighty-degree (180°) rotation to reverse the direction of travel. It is called a “U-turn” because the maneuver looks like the letter U. In some jurisdictions, the maneuver is illegal, while in others, it is treated as a more ordinary turn, merely extended. In still other areas, lanes are occasionally marked “U-turn permitted” or even “U-turn only.”

For example, Florida Statute § 316.075 expressly allows U-Turns, with some exceptions.
316.075 Traffic control signal devices.—
   (a) Green indication.—
      2. Vehicular traffic facing a green arrow signal, shown alone or in combination with another indication, as directed by the manual, may cautiously enter the intersection only to make the movement indicated by such arrow, or such other movement as is permitted by other indications shown at the same time, except the driver of any vehicle may U-turn, so as to proceed in the opposite direction unless such movement is prohibited by posted traffic control signs.

Despite being expressly allowed, U-turns frequently surprise drivers in trailing cars (i.e., “trailing drivers”). The trailing driver sees a preceding car's left turn indicator lamp and expects the leading car to make a left turn, not a U-turn. The trailing driver leaves enough space between his or her trailing car and the leading car for a left turn. However, when the leading car, in fact, makes a U-turn instead of the expected left turn, the distance between the cars may not be enough to prevent a collision.

Likewise, oncoming and laterally incoming (i.e., from left or right) vehicle drivers and pedestrians might expect a car in the left turn lane or with only its left turn indicator light flashing to make a left turn and not a U-turn. Other drivers and pedestrians misinterpreting a U-turn as merely a left turn can lead to collisions. The collisions might not be limited to the turning vehicle but could involve third-party vehicles.

To protect drivers and to help drivers indicate their intentions to surrounding drivers, states have enacted laws that set the requirements for headlamps, taillamps, stop lamps, and turn signals. For example, Chapter 316 of the 2020 Florida Statutes set the requirements in Florida.
316.217 When lighted lamps are required.—
   (1) Every vehicle operated upon a highway within this state shall display lighted lamps and illuminating devices as herein respectively required for different classes of vehicles, subject to exceptions with respect to parked vehicles, under the following conditions; . . .
      (c) Stop lights, turn signals, and other signaling devices shall be lighted as prescribed for use of such devices.
316.220 Headlamps on motor vehicles.—
   (1) Every motor vehicle shall be equipped with at least two headlamps with at least one on each side of the front of the motor vehicle.
316.221 Taillamps.—
   (1) Every motor vehicle . . . shall be equipped with at least two taillamps mounted on the rear.
316.222 Stop lamps and turn signals.—
   (1) Every motor vehicle . . . shall be equipped with two or more stop lamps . . .
   (2) Every motor vehicle . . . shall be equipped with electric turn signal lamps.
316.224 Color of clearance lamps, identification lamps, side marker lamps, backup lamps, reflectors, and deceleration lights.—
   (1) Front clearance lamps, identification lamps, and those marker lamps and reflectors mounted on the front or on the side near the front of a vehicle shall display or reflect an amber color.
   (2) Rear clearance lamps, identification lamps, and those marker lamps and reflectors mounted on the rear or on the sides near the rear of a vehicle shall display or reflect a red color.
   (3) All lighting devices and reflectors mounted on the rear of any vehicle shall display or reflect a red color, except the stop light or other signal device, which may be red, amber, or yellow, and except that the light illuminating the license plate shall be white and the light emitted by a backup lamp shall be white or amber.

Florida statutes do not mention an indicator for vehicles making U-turns.

### BRIEF SUMMARY OF THE INVENTION

An object of the invention is to provide a wireless vehicle U-turn indicator light for motor vehicles that overcomes the disadvantages of the devices of this general type and of the prior art.

With the foregoing and other objects in view there is provided, in accordance with the invention, a wireless U-turn indicator lamp. The wireless U-turn indicator lamp includes a switch, a wireless transmitter, a wireless receiver, a receiver switch, an indicator lamp. The switch is activated before making a U-turn to illuminate the indicator lamp. The wireless transmitter is connected to the switch. The wireless transmitter transmits a signal when the switch is activated. The wireless receiver receives the signal from the wireless transmitter. The receiver switch is connected to the wireless receiver. The receiver switch is activated when the wireless receiver receives the signal. The indicator lamp is connected to the receiver switch. The indicator lamp illuminates when the receiver switch is activated.

The invention can be incorporated in a version that is sold as an aftermarket addition. The aftermarket addition includes battery-powered, wireless, adherable components that and can be added without requiring professional installation. Each component (e.g., the switch unit, the transmitter unit, and indicator lamp unit) can be battery powered. The switch unit can include an adhesive backing for attaching the button to a surface such as the dashboard or steering wheel. The indicator lights include a magnet or adhesive to attach the light to a surface of the vehicle. In the aftermarket version, the switch of the switch unit can include two positions: a first position is for activating the indicator lamp unit and a second position is for deactivating the indicator lamp unit. The switch unit can include only a single button that when pressed causes the indicator lamp unit to illuminate for a set amount of time (e.g., thirty seconds) and then deactivate without requiring the switch unit to be moved to the second position.

The invention can be incorporated as a built-in feature of a vehicle. The switch unit would be built into the steering wheel assembly, for example, as a button on the steering wheel or as a button on a stalk extending from the steering column. Like a left or right turn indicator, the U-turn indicator can be manually activated. Then, the U-turn indicator can be switched off by turning the steering wheel to make the U-turn. A manual off switch can be included in case the automatic off switch does not deactivate the U-turn indicator after the U-turn has been made.

The cost and complexity of adding a device with wires is almost prohibitive. The submitted device is readily fixed for the vehicles.

Other features that are considered as characteristic for the invention are set forth in the appended claims.

Although the invention is illustrated and described herein as embodied in a wireless U-turn indicator lamp, the invention should not be limited to the details shown in those embodiments because various modifications and structural changes may be made without departing from the spirit of the invention while remaining within the scope and range of equivalents of the claims.

The construction and method of operation of the invention and additional objects and advantages of the invention is best understood from the following description of specific embodiments when read in connection with the accompanying drawings.

### BRIEF DESCRIPTION OF THE SEVERAL VIEWS OF THE DRAWING

FIG. 1 is a front elevational view of an indicator lamp unit according to the invention.

FIG. 2 is a front elevational view of an automobile with two indicator lamp units like the indicator lamp unit shown in FIG. 1.

FIG. 3 is a rear elevational view of the automobile shown in FIG. 2 with an indicator lamp unit like the indicator lamp unit shown in FIG. 1.

FIG. 4 is a right elevational view of the automobile shown in FIG. 2 with an indicator lamp unit like the indicator lamp unit shown in FIG. 1.

FIG. 5 is a left elevational view of the automobile shown in FIG. 2 with an indicator lamp unit like the indicator lamp unit shown in FIG. 1.

FIG. 6 is a rear sectional view of the automobile shown in FIG. 2 showing a dashboard and steering wheel of the automobile.

FIG. 7 is a front bottom perspective view of the indicator lamp unit shown in FIG. 1.

FIG. 8 is a side elevational view of a switch unit according to the invention.

FIG. 9 is a schematic view of a wireless U-turn indicator according to the invention.

### DETAILED DESCRIPTION OF THE INVENTION

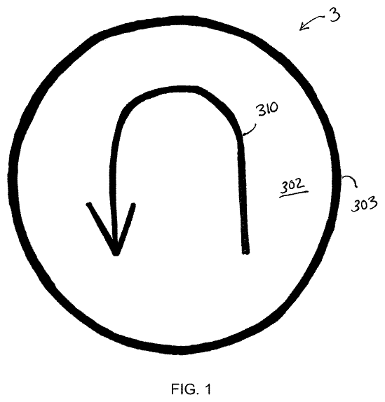

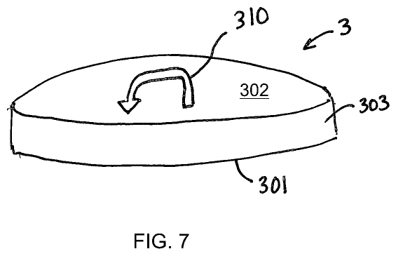

FIGS. 1 and 7 shows a preferred embodiment of an indicator lamp unit 3. The indicator lamp unit 3 includes a face 302 made of translucent material. The face 302 has an upside-down U-shaped indicia 310. A wall 303 of the indicator lamp unit 3 is present, which is connected to base 301. Base 301 can be attached to a part of an automobile. In one preferred embodiment, adhesive is placed on the rear of the base 301 for adhering the indicator lamp unit 3 to the automobile. In an alternate embodiment, a magnet is disposed on the rear of the base 301 for magnetically adhering the indicator lamp unit 3 to the automobile.

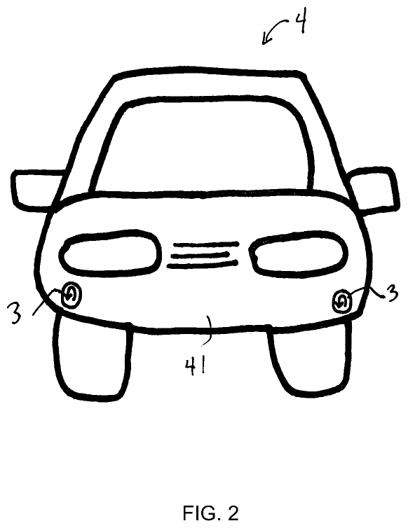

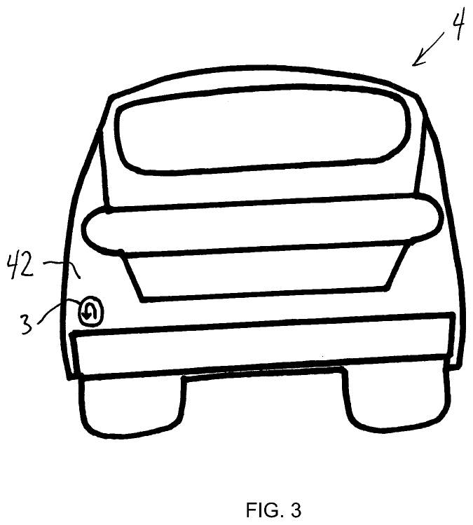

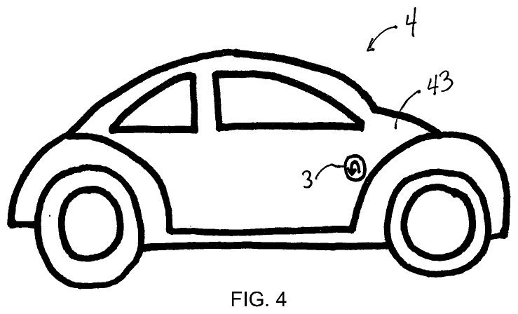

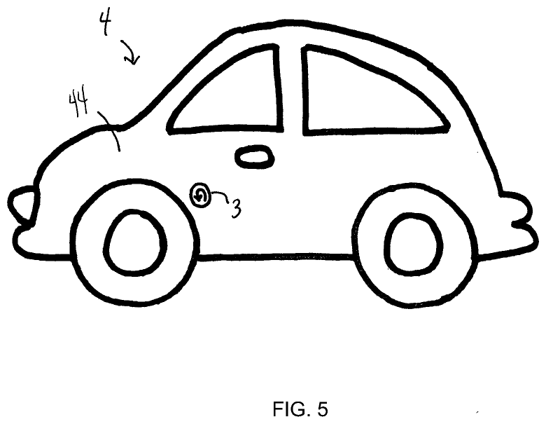

FIGS. 2-5 show an automobile 4. FIG. 2 shows a front bumper 41 of the automobile 4. An indicator lamp unit 3 is placed on each side of the front bumper 41. FIG. 3 shows the automobile 4 with an indicator lamp unit 3 disposed on the rear driver-side quarter panel. FIG. 4 shows the automobile 4 with an indicator lamp unit 3 on a front passenger-side quarter panel. FIG. 5 shows the automobile 4 with an indicator lamp unit 3 on a front driver-side quarter panel 44.

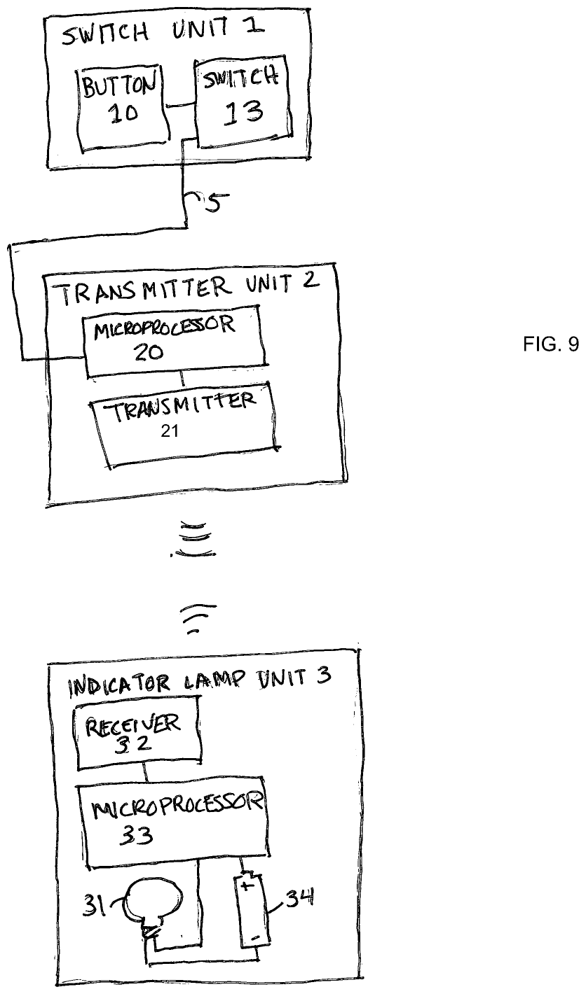

FIG. 9 shows a preferred embodiment of a wireless U-turn indicator. The wireless U-turn indicator includes a switch unit 1, a transmitter unit 2, and an indicator lamp unit 3.

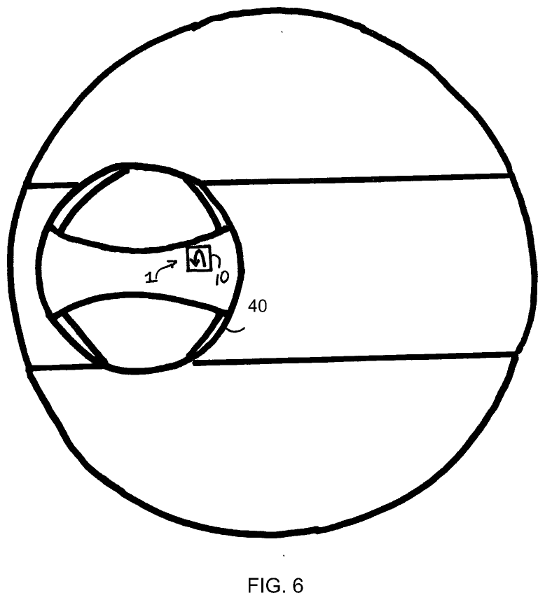

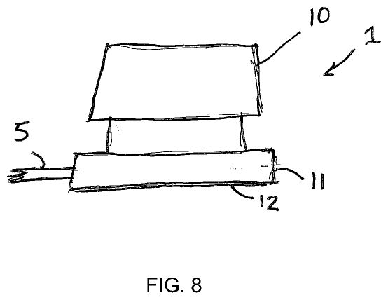

FIGS. 6 and 8 show the switch unit 1. The switch unit 1 includes a button 10, backing 11, adhesive 12, and a switch 13. The button 10 is to be pressed to indicate a U-turn is about to be made. The backing 11 supports the button 10 and houses the switch 13. The adhesive 12 is disposed on the backing and is used for attaching the button 10 to a steering wheel 40 of an automobile 4. The switch 13 is connected to the button 10. The switch 13 is closed when the button is pressed. A lead 5 interconnects the switch unit 1 and the transmitter unit 2.

The transmitter unit 2 includes a microprocessor 20 and a wireless transmitter 21. The microprocessor 20 is connected to the switch 13. The microprocessor 20 sends a signal to the wireless transmitter 21 when the switch 13 is closed. The wireless transmitter 21 transmits a radio-frequency signal according to a protocol when the wireless transmitter 21 receives the signal from the microprocessor 20. The protocol sold under the trademark BLUETOOTH® is a preferred embodiment of the protocol.

The indicator lamp unit 3 includes a cylindrical case 30, a wireless receiver 32, a microprocessor 33, an indicator lamp 31, a battery 34, and adhesive which is no shown. The cylindrical case 30 has a base 301, a face 302, and a wall 303. The wireless receiver 32 is disposed in the cylindrical case 30 and is configured to send a signal to the microprocessor 33 after receiving the radio-frequency signal from the wireless transmitter 21. The microprocessor 33 switches the indicator lamp 31 on after receiving the signal from the wireless receiver 32. The battery 34 is disposed in the cylindrical case 30 and provides electricity to the indicator lamp 31. The indicator lamp 31 is disposed in the face 302 of the cylindrical case 30 and has an upside-down U-shaped lens 310. The adhesive is disposed on the base 301 of the cylindrical case 30. The adhesive can adhere the cylindrical case 30 to a surface of the automobile 4, for example, on the front bumper 41, the rear driver side quarter panel 42, the front passenger side quarter panel 43, and the front driver side quarter panel 44.

What is claimed is:

1. A wireless U-turn indicator lamp, comprising:
a switch to be activated before making a U-turn;
a wireless transmitter being connected to said switch, said wireless transmitter transmitting a signal when said switch is activated;
a wireless receiver for receiving the signal from said wireless transmitter;
a receiver switch being connected to said wireless receiver, said receiver switch being activated when said wireless receiver receives the signal; and
an indicator lamp being connected to said receiver switch, said indicator lamp illuminating when said receiver switch is activated.

2. A wireless U-turn indicator, comprising:
a switch unit including a button, backing, adhesive, and a switch; said button to be pressed to indicate a U-turn is about to be made; said backing supporting said button; said adhesive being disposed on said backing for attaching said button to a steering wheel of an automobile; said switch being connected to said button, said switch being closed when said button is pressed;
a transmitter unit including a microprocessor and a wireless transmitter, said microprocessor being connected to said switch, said microprocessor sending a signal to said wireless transmitter when said switch is closed, said wireless transmitter transmitting a radio-frequency signal according to a protocol when said wireless transmitter receives the signal from said microprocessor;
an indicator lamp unit including a cylindrical case, a wireless receiver, a microprocessor, an indicator lamp, a battery, and adhesive; said cylindrical case having a base, a face, and a wall, said wireless receiver being disposed in said cylindrical case and being configured to send a signal to said microprocessor after receiving the radio-frequency signal from said wireless transmitter, said microprocessor switching said indicator lamp on after receiving the signal from said wireless receiver; said battery being disposed in said cylindrical case and providing electricity to said indicator lamp; said indicator lamp being disposed in said face of said cylindrical case and having an upside-down U-shaped lens; and said adhesive being disposed on said back of said cylindrical case for adhering said cylindrical case to a surface of the automobile.

3. A wireless U-turn indicator, comprising:
a switch unit for placement within an automobile within reach of a driver, said switch unit including a switch, said switch being configured to be activated by a driver to indicate a U-turn is about to be made;
a transmitter unit including a wireless transmitter, said transmitter unit being connected to said switch unit, said wireless transmitter transmitting a radio-frequency signal when said switch is activated; and
an indicator lamp unit for placement on an exterior of the automobile, said indicator lamp unit including an indicator lamp, a U-turn indicia, said U-turn indicia being illuminable by said indicator lamp; and a wireless receiver, said wireless receiver being configured to switch on said indicator lamp after receiving the radio-frequency signal from said wireless transmitter.

4. The wireless U-turn indicator according to claim 3, wherein said switch unit includes a button, said button to be pressed to indicate a U-turn is about to be made

5. The wireless U-turn indicator according to claim 3, wherein said switch unit includes adhesive for attaching said switch unit to a surface within the interior of the automobile.

6. The wireless U-turn indicator according to claim 3, wherein said transmitter unit includes a microprocessor, said microprocessor being connected to said switching unit, said microprocessor sending a signal to said wireless transmitter when said switching unit is activated.

7. The wireless U-turn indicator according to claim 3, wherein said indicator lamp unit includes a microprocessor connected to said wireless receiver, said wireless receiver being configured to send a signal to said microprocessor after receiving the radio-frequency signal from said wireless transmitter, said microprocessor switching on said indicator lamp after receiving the signal from said wireless receiver.

8. The wireless U-turn indicator according to claim 3, wherein said U-turn indicia is an upside-down U-shaped indicia.

9. The wireless U-turn indicator according to claim 3, wherein said indicator lamp unit includes adhesive for attaching said indicator lamp unit to an exterior of the automobile.

10. The wireless U-turn indicator according to claim 3, wherein said indicator lamp unit includes a magnet for attaching said indicator lamp unit to an exterior of the automobile.
